(19) United States
(12) Patent Application Publication
(10) Pub. No.: US 2025/0229526 A1
(43) Pub. Date: Jul. 17, 2025

(54) PRINTING APPARATUS

(71) Applicant: SEIKO EPSON CORPORATION, Tokyo (JP)

(72) Inventor: Daisuke NISHIZAWA, SHIOJIRI-SHI (JP)

(21) Appl. No.: 19/017,984

(22) Filed: Jan. 13, 2025

(30) Foreign Application Priority Data
Jan. 16, 2024 (JP) 2024-004395

(51) Int. Cl. B41J 2/14

(52) U.S. Cl. CPC B41J 2/14024; B41J 2002/14362; B41J 2202/19

(57) ABSTRACT

A printing apparatus includes a head unit base holding unit including a first head unit base holding unit that holds one end of the head unit base, and a second head unit base holding unit that holds the other end of the head unit base, a first fixation member configured to fix the head unit base to the first head unit base holding unit, and a second fixation member configured to fix the head unit base to the second head unit base holding unit, wherein the head unit base and the head unit base holding unit are fixed to each other by placing the head unit base on a first upper surface of the first head unit base holding unit and a second upper surface of the second head unit base holding unit and sandwiching the head unit base between the first fixation member and the second fixation member.

The present application is based on, and claims priority from JP Application Serial Number 2024-004395, filed Jan. 16, 2024, the disclosure of which is hereby incorporated by reference herein in its entirety.

### BACKGROUND

### 1. Technical Field

The present disclosure relates to a printing apparatus.

### 2. Related Art

Hitherto, as described in JP-A-2016-132226, there has been known an apparatus including a plurality of heads and a head unit that suppresses warpage caused by heat from a heater.

In the apparatus described in JP-A-2016-132226, there may be a risk of deformation caused by a structure of the head unit.

### SUMMARY

A printing apparatus includes a head unit base configured to support a plurality of heads, a head unit base holding unit including a first head unit base holding unit that holds one end of the head unit base in a longitudinal direction of the head unit base, and a second head unit base holding unit that holds the other end of the head unit base in the longitudinal direction of the head unit base, a first fixation member configured to fix the head unit base to the first head unit base holding unit, and a second fixation member configured to fix the head unit base to the second head unit base holding unit, wherein the head unit base and the head unit base holding unit are fixed to each other by placing the head unit base on a first upper surface of the first head unit base holding unit and a second upper surface of the second head unit base holding unit and sandwiching the head unit base between the first fixation member and the second fixation member in the longitudinal direction.

### BRIEF DESCRIPTION OF THE DRAWINGS

FIG. 1 is a schematic view illustrating a main part of a printing apparatus as viewed from a front end of a head unit.

FIG. 2 is a perspective view illustrating the head unit.

FIG. 3 is a cross-sectional view illustrating the front end of the head unit.

FIG. 4 is a perspective view illustrating the front end of the head unit from which a first gap member is removed.

FIG. 5 is a cross-sectional view illustrating a rear end of the head unit.

### DESCRIPTION OF EMBODIMENTS

With reference to the drawings, an embodiment is described below. Note that the directions in the drawings are described by using a three-dimensional coordinate system. For the convenience of description, description is made on while a positive direction of a Z axis is referred to as an upward direction, upward, or, simply, up and a negative direction thereof is referred to as a downward direction, downward, or, simply, down, a positive direction of an X axis is referred to as a right direction, rightward, or, simply, right and a negative direction thereof is referred to as a left direction, leftward, or, simply, left, and a positive direction of a Y axis is referred to as a rear direction, rearward, or, simply, rear, and a negative direction thereof is referred to as a front direction, frontward, or, simply, front.

### 1. Configuration of Printing Apparatus

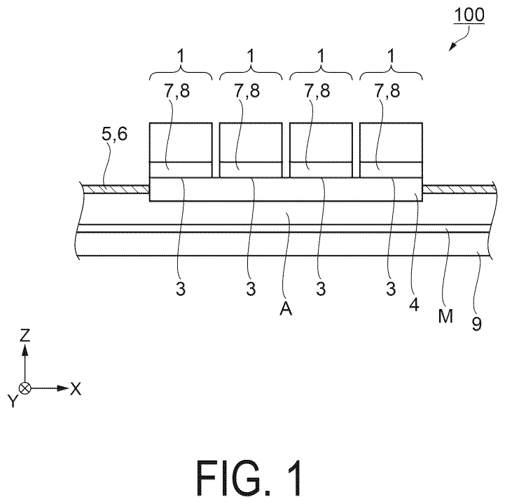

As illustrated in FIG. 1, a printing apparatus 100 includes a plurality of head units 1, a carriage 4, and a transport unit 9. One head unit 1 is configured to include a head 3, a head unit base 7, and a head unit base holding unit 8. Note that it is assumed that the head 3 is configured by a plurality of heads. The head unit base 7 supports the head 3. The head unit base 7 is placed and held on the head unit base holding unit 8.

The plurality of head units 1 are mounted to the carriage 4. Specifically, each of the plurality of head unit bases 7 is fixed to the carriage 4. In other words, each of the plurality of head unit bases 7 is fixed to the carriage 4 by unit of the head unit 1 in which the head unit base 7 and the head unit base holding unit 8 are fixed to each other. The carriage 4 is attached to a carriage belt 5. The carriage 4 and the plurality of head units 1 fixed to the carriage 4 moves to the right and the left along a carriage shaft 6 as the carriage belt 5 is moved by a carriage motor (omitted in illustration). The head 3 that is mounted to the carriage 4 and moves is referred to as a so-called serial-type head.

The head 3 is an ink-jet head, and can eject ink droplets of respective colors including cyan, magenta, yellow, and black (C, M, Y, and K), for example. Note that the ink colors may include, for example, shades of C, M, Y, and K, and any combination of four or more colors is also possible. The head unit 1 ejects an ink droplet from each of the heads 3 while moving to perform printing on a medium M placed below.

The transport unit 9 includes a transport roller, a transport motor (omitted in illustration), and the like, and transports the medium M in the right-and-left direction. Note that the medium M may be any one of plain paper, synthetic paper, a film, and fabric.

In the serial-type head 3 illustrated in FIG. 1, a longitudinal direction of the head unit base 7, which is described later, is a direction intersecting with a transport direction in which the transport unit 9 transports the medium M, is a front-and-rear direction, and is a width direction of the medium M. Further, the transport unit 9 may be configured to transport the medium M in the front-and-rear direction. In this case, the longitudinal direction of the head unit base 7 is the transport direction in which the transport unit 9 transports the medium M, is the front-and-rear direction, and is a length direction of the medium M.

Note that the printing apparatus 100 may be configured to include a so-called line-type head in which the head 3 is fixed, instead of a serial type.

### 2. Configuration of Head Unit

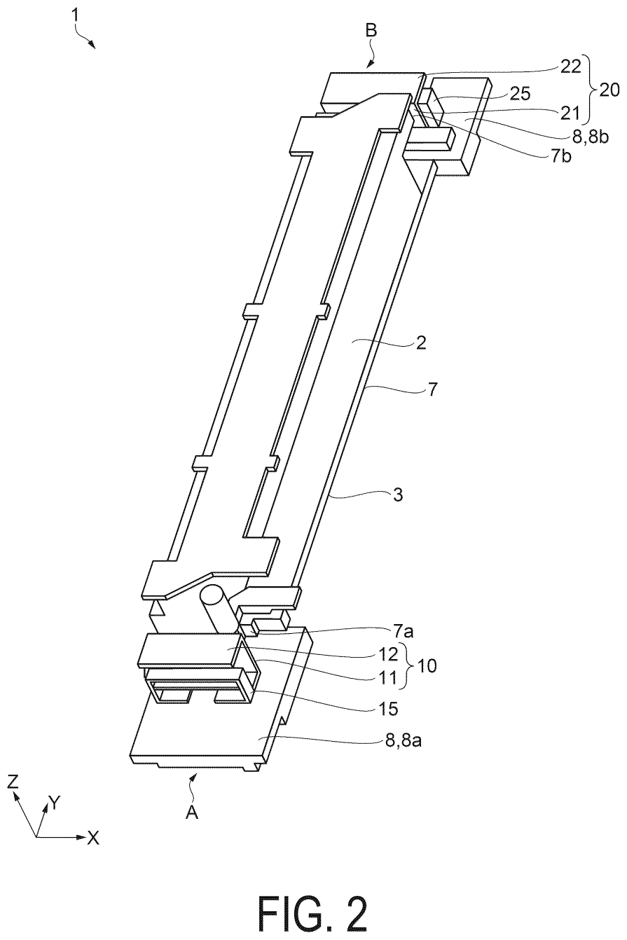

FIG. 2 illustrates one head unit 1. In the following description, the front of the head unit 1 is referred to as a front end A, and the rear thereof is referred to as a rear end B.

A head unit main body unit 2 of the head unit 1 is held by the head unit base holding unit 8. The head unit main body unit 2 is configured to include the head unit base 7 and the head 3. The head 3 is arranged below the head unit main body unit 2.

The head unit base holding unit 8 includes a first head unit base holding unit 8a and a second head unit base holding unit 8b that are arranged as independent mechanisms on the front and rear sides.

The head unit base 7 is stretched between the first head unit base holding unit 8a and the second head unit base holding unit 8b. In the following description, the front of the head unit base 7 is referred to as one end 7a, and the rear thereof is referred to as the other end 7b.

In the front-and-rear direction being the longitudinal direction of the head unit base 7, the first head unit base holding unit 8a holds the one end 7a of the head unit base 7, and the second head unit base holding unit 8b holds the other end 7b of the head unit base 7.

The head unit base 7 is fixed to the first head unit base holding unit 8a by a first fixation member 10 at the front end A, and is fixed to the second head unit base holding unit 8b by a second fixation member 20 at the rear end B.

The first fixation member 10 includes a first member 11 and a second member 12. The second fixation member 20 includes a third member 21 and a fourth member 22.

Further, in the head unit 1, a first gap member 15 that is used for adjusting the height of the second member 12 at the front end A and a second gap member 25 that is used for adjusting the height of the fourth member 22 at the rear end B are arranged.

### 2-1. Configuration of Front End of Head Unit

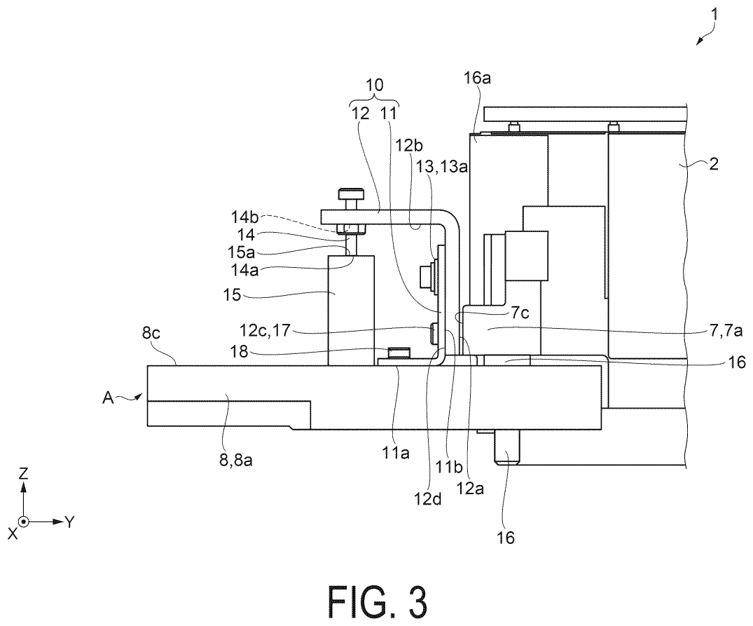

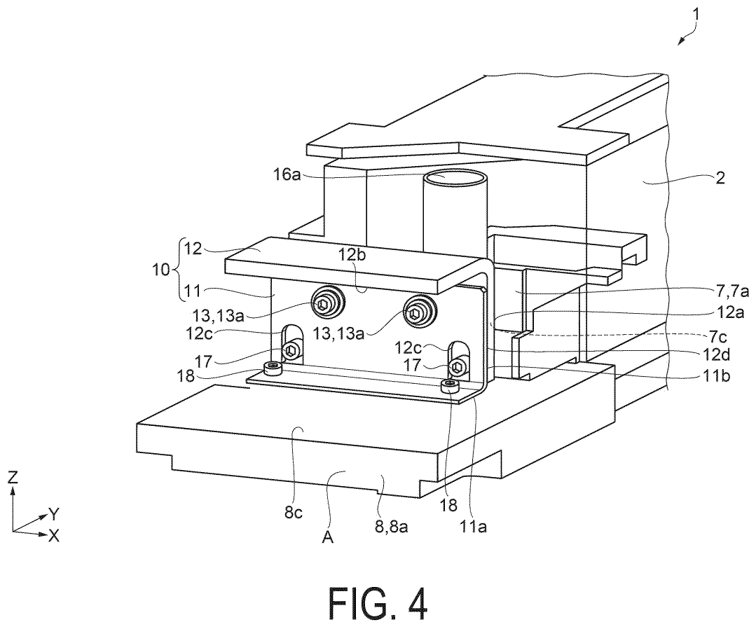

With reference to FIG. 3 to FIG. 4, a configuration of the front end A of the head unit 1 is described according to an order of attaching the head unit main body unit 2 to the head unit base holding unit 8.

First, a first pin 16 fixed to the first head unit base holding unit 8a of the head unit base holding unit 8 is inserted into a first cylinder 16a of the head unit base 7 of the head unit main body unit 2, and then is positioned.

The one end 7a of the head unit base 7 of the head unit main body unit 2 is placed on a first upper surface 8c being the upper surface of the first head unit base holding unit 8a.

As described above, the first fixation member 10 includes the first member 11 and the second member 12. The one end 7a of the head unit base 7 is fixed from a first side surface 7c to the second member 12 by a fifth screw 17. In other words, the second member 12 is fixed to the first side surface 7c of the head unit base 7. Note that one fifth screw 17 may be fixed. However, since a plurality of screws achieve stable fixation, the plurality of screws may be provided. The first member 11 is fixed to the first upper surface 8c of the first head unit base holding unit 8a by a seventh screw 18. Note that one seventh screw 18 may be fixed. However, since a plurality of screws achieve stable fixation, the plurality of screws may be provided.

The second member 12 is arranged between the first side surface 7c of the head unit base 7 and the first member 11.

The first member 11 includes a first surface 11a and a second surface 11b. The first surface 11a of the first member 11 contacts with the first upper surface 8c of the first head unit base holding unit 8a, and is fixed thereto. The second surface 11b extends and is bent at a substantially right angle with respect to the first surface 11a, and is continuous therewith so as to form a so-called L-like shape.

The second member 12 includes a third surface 12a, a fourth surface 12b, and a fourth contact surface 12d. The third surface 12a of the second member 12 is arranged to face the first side surface 7c of the head unit base 7. The fourth surface 12b is continuous with the third surface 12a so as to form an L-like shape. The fourth contact surface 12d contacts with the second surface 11b of the first member 11.

The fourth surface 12b of the second member 12 is arranged at a position facing the first upper surface 8c of the first head unit base holding unit 8a. Further, a third screw hole 14b, which is described later, is provided in the fourth surface 12b.

the second surface 11b of the first member 11 is arranged to face the first side surface 7c of the head unit base 7 across the third surface 12a of the second member 12.

In other words, the first fixation member 10 includes the first member 11 that is fixed to the first upper surface 8c of the first head unit base holding unit 8a, the second member 12 that is arranged between the first side surface 7c and the first member 11, the first side surface 7c being a side surface of the head unit base 7 and a side surface of the head unit base 7 on the one end 7a side in the longitudinal direction of the head unit base 7, and a first screw 13, which is described later.

A first gap distance change member that changes the distance between the first member 11 and the second member 12 corresponds to the first screw 13. The first screw 13 is inserted into a first screw hole 13a provided in the second surface 11b of the first member 11 and the third surface 12a of the second member 12. The first screw 13 can change the distance between the first member 11 and the second member 12. In other words, the first screw 13 can change the position of the second member 12 in the front-and-rear direction with respect to the position of the first member 11.

The first screw 13 is temporarily fixed, and hence the second member 12 is movable with respect to the first member 11. Note that one first screw 13 may be fixed. However, since a plurality of screws achieve stable fixation, the plurality of screws may be provided.

As illustrated in FIG. 4, the fifth screw 17 can be guided by an elongated first guide 12c of the first member 11. As described above, the one end 7a of the head unit base 7 is fixed to the second member 12 by the fifth screw 17. The fifth screw 17 can be guided by the first guide 12c of the first member 11. At the same time, the one end 7a of the head unit base 7 is movable in the up-and-down direction as the second member 12 moves.

In other words, the positions of the head unit base 7 and the second member 12 can be changed in the up-and-down direction with respect to the positions of the first upper surface 8c of the first head unit base holding unit 8a and the first member 11.

The first gap member 15 is arranged between the first upper surface 8c of the first head unit base holding unit 8a and the fourth surface 12b of the second member 12, while generating a gap with the fourth surface 12b.

A third gap distance change member is a third screw 14 inserted into the third screw hole 14b of the second member 12. The third screw 14 can change and adjust a distance between a first gap member upper surface 15a being an upper surface of the first gap member 15 and the fourth surface 12b. Note that one third screw 14 may be fixed. However, since a plurality of screws achieve stable adjustment, the plurality of screws may be provided.

The third screw 14 changes the distance between the first gap member 15 and the fourth surface 12b. With this, the position of the second member 12 with respect to the position of the first member 11 can be changed and adjusted in the up-and-down direction.

In other words, the third screw 14 can change and adjust the position of the one end 7a of the head unit base 7 in the height direction with respect to the first upper surface 8c of the first head unit base holding unit 8a. The third screw 14 achieves linear height adjustment.

Note that a third screw distal end 14a of the third screw 14 moves in the up-and-down direction. When the third screw distal end 14a moves downward, the third screw distal end 14a contacts with the first gap member upper surface 15a of the first gap member 15, and then the downward movement is stopped.

The third screw 14 changes and adjusts the position of the one end 7a of the head unit base 7 in the height direction with respect to the first upper surface 8c of the first head unit base holding unit 8a. After that, when the first screw 13 is completely fastened, the distance between the first member 11 and the second member 12 are fixed to each other.

Note that, even when a gap may be generated between the first head unit base holding unit 8a and the head unit base 7 due to the third screw 14, the head unit base 7 can be placed on the first upper surface 8c of the first head unit base holding unit 8a via the first fixation member 10.

### 2-2. Configuration of Rear End of Head Unit

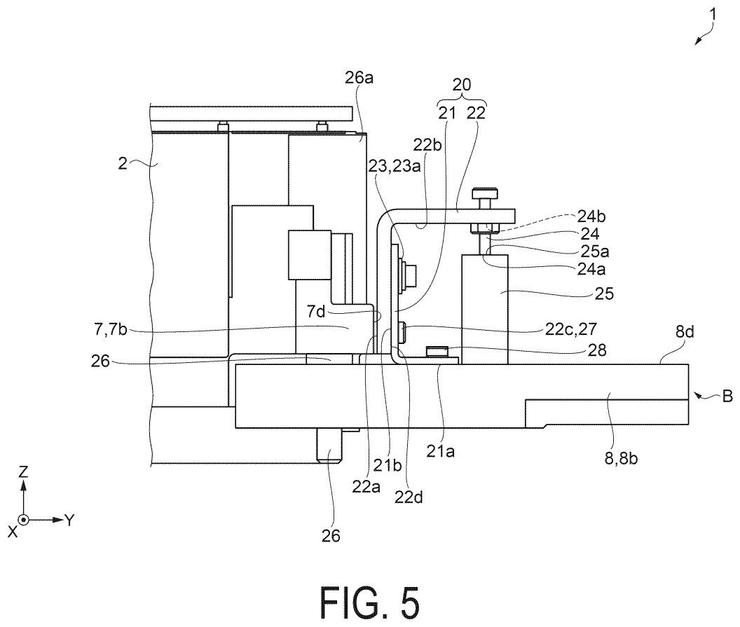

With reference to FIG. 5, a configuration of the rear end B of the head unit 1 is described. Note that the configuration of the rear end B of the head unit 1 is symmetrical to the configuration of the front end A of the head unit 1 described above.

A second pin 26 fixed to the second head unit base holding unit 8b of the head unit base holding unit 8 is inserted into a second cylinder 26a of the head unit base 7 of the head unit main body unit 2, and then is positioned.

The other end 7b of the head unit base 7 of the head unit main body unit 2 is placed on a second surface 8d being the upper surface of the second head unit base holding unit 8b.

As described above, the second fixation member 20 includes the third member 21 and the fourth member 22. The other end 7b of the head unit base 7 is fixed from a second side surface 7d to the fourth member 22 by a sixth screw 27. In other words, the fourth member 22 is fixed to the second side surface 7d of the head unit base 7. Note that one sixth screw 27 may be fixed. However, since a plurality of screws achieve stable fixation, the plurality of screws may be provided.

The third member 21 is fixed to the second surface 8d of the second head unit base holding unit 8b by an eighth screw 28. Note that one eighth screw 28 may be fixed. However, since a plurality of screws achieve stable fixation, the plurality of screws may be provided.

The fourth member 22 is arranged between the second side surface 7d of the head unit base 7 and the third member 21.

The third member 21 includes a fifth surface 21a and a sixth surface 21b. The fifth surface 21a contacts with the second surface 8d of the second head unit base holding unit 8b, and is fixed thereto. The sixth surface 21b is continuous with the fifth surface 21a so as to form an L-like shape.

The fourth member 22 includes a seventh surface 22a, an eighth surface 22b, and an eighth contact surface 22d. The seventh surface 22a faces the second side surface 7d of the head unit base 7. The eighth surface 22b is continuous with the seventh surface 22a so as to form an L-like shape. The eighth contact surface 22d contacts with the sixth surface 21b of the third member 21.

The eighth surface 22b of the fourth member 22 is arranged at a position facing the second surface 8d of the second head unit base holding unit 8b. Further, a fourth screw hole 24b, which is described later, is provided in the eighth surface 22b.

The sixth surface 21b of the third member 21 is arranged to face the second side surface 7d of the head unit base 7 across the seventh surface 22a of the fourth member 22.

In other words, the second fixation member 20 includes the third member 21 that is fixed to the second surface 8d of the second head unit base holding unit 8b, the fourth member 22 that is arranged between the second side surface 7d and the third member 21, the second side surface 7d being a side surface of the head unit base 7 and a side surface of the head unit base 7 on the other end 7b side in the longitudinal direction of the head unit base 7, and a second screw 23, which is described later.

A second gap distance change member that changes the distance between the third member 21 and the fourth member 22 corresponds to the second screw 23. The second screw 23 is inserted into a second screw hole 23a provided in the sixth surface 21b of the third member 21 and the seventh surface 22a of the fourth member 22. The second screw 23 can change the distance between the third member 21 and the fourth member 22. In other words, the second screw 23 can change the position of the fourth member 22 in the front-and-rear direction with respect to the position of the third member 21.

The second screw 23 is temporarily fixed, and hence the fourth member 22 is movable with respect to the third member 21. Note that one second screw 23 may be fixed. However, since a plurality of screws achieve stable fixation, the plurality of screws may be provided.

The sixth screw 27 can be guided by an elongated second guide 22c of the third member 21. As described above, the other end 7b of the head unit base 7 is fixed to the fourth member 22 by the sixth screw 27. The sixth screw 27 can be guided by the second guide 22c of the third member 21. At the same time, the other end 7b of the head unit base 7 is movable in the up-and-down direction as the fourth member 22 moves. In other words, the positions of the head unit base 7 and the fourth member 22 can be changed in the up-and-down direction with respect to the positions of the second surface 8d of the second head unit base holding unit 8b and the third member 21.

The second gap member 25 is arranged between the second surface 8d of the second head unit base holding unit 8b and the eighth surface 22b of the fourth member 22, while generating a gap with the eighth surface 22b.

A fourth gap distance change member is a fourth screw 24 inserted into the fourth screw hole 24b of the fourth member 22. The fourth screw 24 can change and adjust a distance between a second gap member upper surface 25a being an upper surface of the second gap member 25 and the eighth surface 22b.

Note that one fourth screw 24 may be fixed. However, since a plurality of screws achieve stable adjustment, the plurality of screws may be provided.

The fourth screw 24 changes the distance between the second gap member 25 and the eighth surface 22b. With this, the position of the fourth member 22 with respect to the position of the third member 21 can be changed and adjusted in the up-and-down direction.

In other words, the fourth screw 24 can change and adjust the position of the other end 7b of the head unit base 7 in the height direction with respect to the second surface 8d of the second head unit base holding unit 8b. The fourth screw 24 achieves linear height adjustment.

Note that a fourth screw distal end 24a of the fourth screw 24 moves in the up-and-down direction. When fourth screw distal end 24a moves downward, fourth screw distal end 24a contacts with the of second gap member upper surface 25a of the second gap member 25, and then the downward movement is stopped.

The fourth screw 24 changes and adjusts the position of the other end 7b of the head unit base 7 in the height direction with respect to the second surface 8d of the second head unit base holding unit 8b. After that, when the second screw 23 is completely fastened, the distance between the third member 21 and the fourth member 22 are fixed to each other. Note that, even when a gap is generated between the second head unit base holding unit 8b and the head unit base 7 due to the fourth screw 24, the head unit base 7 can be placed on the second surface 8d of the second head unit base holding unit 8b via the second fixation member 20.

2-3. With regard to Fixation of Each Constituent Component in Head Unit

As described above, at the front end A of the head unit 1, on the first upper surface 8c being the upper surface of the first head unit base holding unit 8a and the rear end B of the head unit 1, the head unit base 7 can be placed and held on the second surface 8d being the upper surface of the second head unit base holding unit 8b.

Further, with the above-mentioned configuration, the head unit base 7 can be switched between the first fixation member 10 and the second fixation member 20 in the longitudinal direction, and the head unit base 7 and the head unit base holding unit 8 can be fixed to each other.

As described above, at the front end A of the head unit 1, even when a gap is generated between the first head unit base holding unit 8a and the head unit base 7 during height adjustment by the third screw 14, the head unit base 7 can be placed and held on the first upper surface 8c of the first head unit base holding unit 8a via the first member 11 and the second member 12 of the first fixation member 10.

Similarly, at the rear end B of the head unit 1, even when a gap is generated between the second head unit base holding unit 8b and the head unit base 7 during height adjustment by the fourth screw 24, the head unit base 7 can be placed and held on the second surface 8d of the second head unit base holding unit 8b via the third member 21 and the fourth member 22 of the second fixation member 20.

At the front end A of the head unit 1, the distance between the first member 11 and the second member 12 of the first fixation member 10 is narrowed by the first screw 13. With this, the first member 11 and the first side surface 7c of the head unit base 7 can be fixed to each other via the second member 12.

Further, when the second side surface 7d of the head unit base 7 and the third member 21 of the second fixation member 20 are fixed to each other, the head unit base 7 can be sandwiched between the first fixation member 10 and the second fixation member 20.

Meanwhile, at the rear end B of the head unit 1, the distance between the third member 21 and the fourth member 22 of the second fixation member 20 is narrowed by the second screw 23. With this, the third member 21 and the second side surface 7d of the head unit base 7 can be fixed to each other via the fourth member 22.

Further, when the first side surface 7c of the head unit base 7 and the first member 11 of the first fixation member 10 are fixed to teach other, the head unit base 7 can be sandwiched between the first fixation member 10 and the second fixation member 20.

The head unit 1 of the printing apparatus 100 according to the above-mentioned embodiment includes the head unit base 7 that supports the head 3 and the head unit base holding unit 8 that includes the first head unit base holding unit 8a and the second head unit base holding unit 8b. The first head unit base holding unit 8a holds the one end 7a of the head unit base 7 in the front-and-rear direction being the longitudinal direction of the head unit base 7. The second head unit base holding unit 8b holds the other end 7b of the head unit base 7 in the longitudinal direction of the head unit base 7.

Further, the head unit 1 includes the first fixation member 10 that fixes the head unit base 7 to the first head unit base holding unit 8a and the second fixation member 20 that fixes the head unit base 7 to the second head unit base holding unit 8b.

In the head unit 1, the head unit base 7 can be placed on the first upper surface 8c being the upper surface of the first head unit base holding unit 8a and the second surface 8d being the upper surface of the second head unit base holding unit 8b. Further, in the head unit 1, the head unit base 7 is sandwiched between the first fixation member 10 and the second fixation member 20 in the longitudinal direction. Thus, the head unit base 7 and the head unit base holding unit 8 can be fixed to each other.

In this manner, the head unit base holding unit 8 of the head unit 1 includes the first head unit base holding unit 8a and the second head unit base holding unit 8b that are arranged as independent mechanisms on the front and rear sides. The head unit base 7 supports the head 3 including the plurality of heads. The head unit base 7 is placed on the first head unit base holding unit 8a and the second head unit base holding unit 8b at the front and rear sides of the head unit 1, respectively. In the head unit 1, when the head unit base 7 is fixed to the head unit base holding unit 8, the head unit base 7 is sandwiched between the first fixation member 10 and the second fixation member 20 in the longitudinal direction, and is thus held.

Incidentally, when the head unit base 7 is fixed to the head unit base holding unit 8, it is assumed that the fixation is performed by a screw or the like in the up-and-down direction, which is different from the above-mentioned embodiment. In such a case, deformation of the head unit base 7, such as warpage, may occur. Further, when the head unit base holding unit 8 is integrally configured, the head unit base 7 may be deformed. In those cases different from the above-mentioned embodiment, deformation due to the structure of the head unit 1 may occur.

When the head unit base 7 is deformed, a position of each head of the heads 3 supported by the head unit base 7 may be changed. As a result, a landing position of an ink droplet ejected onto a medium may be deviated, and printing quality may be degraded.

With the head unit 1 of the printing apparatus 100 according to the above-mentioned embodiment, deformation of the head unit base 7 can be suppressed, and degradation of printing quality can be suppressed.

The embodiment is described above in detail with reference to the drawings. However, the specific configurations are not limited to the embodiment, and may be modified, replaced, deleted, or the like without departing from the gist of the present disclosure.

What is claimed is:

1. A printing apparatus comprising:
a head unit base configured to support a plurality of heads;
a head unit base holding unit including:
a first head unit base holding unit that holds one end of the head unit base in a longitudinal direction of the head unit base; and
a second head unit base holding unit that holds the other end of the head unit base in the longitudinal direction of the head unit base;
a first fixation member configured to fix the head unit base to the first head unit base holding unit; and
a second fixation member configured to fix the head unit base to the second head unit base holding unit, wherein
the head unit base and the head unit base holding unit are fixed to each other by placing the head unit base on a first upper surface of the first head unit base holding unit and a second upper surface of the second head unit base holding unit and sandwiching the head unit base between the first fixation member and the second fixation member in the longitudinal direction.

2. The printing apparatus according to claim 1, wherein
the first fixation member includes:
a first member being fixed to the first upper surface of the first head unit base holding unit;
a second member being arranged between a first side surface and the first member, the first side surface being a side surface of the head unit base and a side surface of the head unit base on the one end side in the longitudinal direction of the head unit base; and
a first gap distance change member configured to change a distance between the first member and the second member,
the second fixation member includes:
a third member being arranged at a position facing a second side surface and being fixed to the second upper surface of the second head unit base holding unit, the second side surface being a side surface of the head unit base and a side surface of the head unit base on the other end side in the longitudinal direction of the head unit base,
the second member is fixed to the first side surface, and
the first member and the first side surface are fixed to each other via the second member by reducing a distance between the first member and the second member by the first gap distance change member, and the head unit base is sandwiched between the first fixation member and the second fixation member by fixing the second side surface and the third member to each other.

3. The printing apparatus according to claim 2, wherein
the second fixation member includes:
the third member;
a fourth member being positioned between the second side surface and the third member and being fixed to the second side surface; and
a second gap distance change member configured to change a distance between the third member and the fourth member, and
the third member and the second side surface are fixed to each other via the fourth member by reducing a distance between the third member and the fourth member by the second gap distance change member, and the head unit base is sandwiched between the first fixation member and the second fixation member.

4. The printing apparatus according to claim 3, wherein
the first member includes:
a first surface being fixed to the first upper surface of the first head unit base holding unit; and
a second surface being continuous with the first surface so as to form an L-like shape,
the second member includes a third surface facing the first side surface, and
the second surface is arranged to face the first side surface across the third surface.

5. The printing apparatus according to claim 4, wherein
the first gap distance change member is a screw, and is inserted into a screw hole provided in the second surface and the third surface.

6. The printing apparatus according to claim 4, wherein
the second member includes the third surface and a fourth surface continuous with the third surface so as to form an L-like shape,
the fourth surface is arranged to face the first upper surface of the first head unit base holding unit,
a gap member is provided between the first upper surface of the first head unit base holding unit and the fourth surface, the gap member being arranged at the first upper surface of the first head unit base holding unit while generating a gap with the fourth surface,
a third gap distance change member is provided to change a distance between an upper surface of the gap member and the fourth surface; and
a position of the head unit base in a height direction with respect to the first head unit base holding unit is configured to be changed by changing a distance between the gap member and the fourth surface by the third gap distance change member.

7. The printing apparatus according to claim 6, wherein
the third gap distance change member is a screw and is inserted into a screw hole provided in the fourth surface, and a distal end of the screw contacts with the upper surface of the gap member.

8. The printing apparatus according to claim 1, comprising
a carriage configured to hold a plurality of the head unit bases, wherein
each of the plurality of the head unit bases is fixed to the carriage by unit of a head unit in which the head unit base and the head unit base holding unit are fixed to each other.
